(19) United States
(12) Patent Application Publication
(10) Pub. No.: US 2009/0312945 A1
(43) Pub. Date: Dec. 17, 2009

(54) NAVIGATION DEVICE AND METHOD, NAVIGATION PROGRAM, AND STORGAGE MEDIUM

(75) Inventors: Tsuyoshi Sakamoto, Saitama (JP); Takahiko Terada, Saitama (JP); Hajime Adachi, Saitama (JP)

Correspondence Address: YOUNG & THOMPSON, 209 Madison Street, Suite 500, Alexandria, VA, 22314, US

(73) Assignee: Pioneer Corporation, Tokyo (JP)

(21) Appl. No.: 12/306,367

(22) PCT Filed: Jul. 3, 2007
(86) PCT No.: PCT/JP2007/063282

§ 371 Date: Feb. 3, 2009

(30) Foreign Application Priority Data
Jul. 3, 2006 (JP) 2006-183431

(51) Int. Cl. G01C 21/26; G08G 1/09

(52) U.S. Cl. 701/208

(57) ABSTRACT

A navigation device (10) having measurement means (12) for measuring both (i) the position of travel of a mobile body driven by a driver and (ii) travel information as information on traveling conditions; determination means (22) for determining the degree of danger based on the measured traveling conditions; point processing means (22 etc.) for adding/subtracting a point corresponding to the determined degree of danger; providing means (19, 20, etc.) for providing the driver with a message; acquisition means (16 etc.) for acquiring accident information; and control means (22 etc.) for controlling, based on the acquired accident information, the providing means so that a predetermined message corresponding to the point obtained by addition/subtraction is provided.

### TECHNICAL FIELD

The present invention relates to a navigation apparatus and method, a navigation program, and a memory medium.

### BACKGROUND ART

For example, such a navigation apparatus is known that displays a traveling direction or the like, on a route to a destination point, along with the travel of a movable body such as a vehicle. Such a navigation apparatus displays a searched route on a map on a display, and displays guidance information, such as an arrow, which indicates the traveling direction of the movable body on the screen of a display apparatus when the movable body is close to a guidance point, such as an intersection, in a route guidance process.

On the other hand, such a technology has been suggested that achieves safe driving of the movable body by monitoring or the like a dangerous drive operation by a driver who drives the movable body. However, if the dangerous drive operation by the driver who drives the movable body and the travel status of the movable body are monitored and the travel of the movable body is automatically controlled, actively, then it is technically difficult to realize easy and low-cost automatic control based on various types of input information.

Thus, a patent document 1 or the like discloses a method of distributing information (so-called, risk information) about a position at which an accident occurred in the past and a situation in which the accident occurred and of providing a message for alerting the driver, on the basis of the distributed information.

Patent document 1: Japanese Patent Application Laid Open NO. 2008-123185
Patent document 2: Japanese Patent Application Laid Open NO. 2002-310680

### DISCLOSURE OF INVENTION

### Subject to be Solved by the Invention

However, according to the patent document 1 or the like, in the case where the message for alerting the driver is provided only on the basis of the judgment of the degree of risk, for example, if the driver changes the level of a variable which is set to judge the degree of risk, the frequency of providing the message or the like can be arbitrarily adjusted. Thus, it is difficult to appropriately warn and alert the driver.

Moreover, according to the patent document 1 or the like, if the message for alerting the driver is provided only on the basis of accident information about the position at which an accident has occurred and the situation (time) in which the accident has occurred, the message is provided for the driver, independently of a driving habit that the driver habitually makes and a driving skill of the driver, such as the level of a drive operation skill. Moreover, the message is provided for the driver only at a predetermined position corresponding to the accident information. Thus, it is difficult to appropriately warn and alert the driver.

In view of the aforementioned problem, it is therefore an object of the present invention to provide a navigation apparatus and method, a navigation program, and a memory medium which enable the driver to perceive a warning and an alert appropriately corresponding to the driving skill of the driver of the movable body and which can effectively realize the proactive safe driving by the driver.

### Means for Solving the Subject

(Navigation Apparatus for Movable Body)

Hereinafter, the navigation apparatus for the movable body of the present invention will be explained.

The above object of the present invention can be achieved by a navigation apparatus for a movable body provided with: a measuring device for measuring travel information, which is information about (i) a travel position of the movable body, which is driven by a driver, and (ii) a travel status (acceleration, an angular velocity, and a speed); a judging device for judging a, degree of risk which indicates a degree of dangerousness in driving of the driver, on the basis of the measured travel information (not stopping near a school); a score processing device for adding or subtracting a score corresponding to the judged degree of risk; a providing device for providing a message for the driver; an obtaining device for obtaining accident information about at least a position, from (iii) the position at which an accident has occurred and (iv) a situation in which the accident has occurred (a time, property damage, turning right without stopping at an intersection); and a controlling device for controlling the providing device to provide a predetermined message (without any change in the content and any output) corresponding to the added or subtracted score (if the total score is greater than or equal to a threshold value), on the basis of the obtained accident information (if it is close to the position at which the accident has occurred).

According to the navigation apparatus of the present invention, by virtue of the measuring device, the travel information, which is information about (i) the travel position of the movable body, which is driven by a driver, and (ii) the travel status (e.g. acceleration, an angular velocity, a speed or the like), is measured. Here, the “movable body” of the present invention may mean a moving device, such as a vehicle, which is driven or operated by a user of the navigation apparatus of the present invention. Alternatively, if the user moves, the movable body may mean the user himself or herself. By virtue of the judging device, the degree of risk, which indicates the degree of dangerousness, in the driving of the driver is judged on the basis of the measured travel information. By virtue of the score processing device, the score corresponding to the judged degree of risk is judged. The obtaining device obtains the accident information about at least the position, from (iii) the position at which the accident has occurred and (iv) the situation in which the accident has occurred. Here, the situation in which the accident has occurred in the present invention means a situation which is related to, for example, a time in which the accident has occurred, whether or not the accident is a property damage accident, the cause of the accident, such as the type of a drive operation, at the position at which the accident has occurred.

If it is recognized that it is close to the position at which the accident has occurred on the basis of the obtained accident information (e.g. the position at which the accident has occurred, or the like) under the control of the controlling device, for example, the predetermined message for alerting the driver is provided for the driver by the providing device in accordance with the added or subtracted score (e.g. the total of the added or subtracted score or the like) (while the content is changed and it is controlled to be outputted or not to be outputted). Here, the provision in the present invention means to make the driver perceive something in some way. For example, a route may be provided with the current position of the movable body through a displaying device having a display screen, which displays the route on a map. Alternatively, the driver may be provided with guidance information, through an audio outputting device which audio-outputs the guidance information.

In the case where the message for alerting the driver is provided on the basis of not the aforementioned score but only the judgment of the degree of risk, for example, if the driver changes the level of a variable which is set to judge the degree of risk, the frequency of providing the message or the like can be arbitrarily adjusted. Thus, it is difficult to appropriately warn and alert the driver.

Moreover, if the message for alerting the driver is provided on the basis of not the aforementioned score but only the accident information about the position at which the accident has occurred and the situation (time) in which the accident has occurred, the message is provided for the driver, independently of the driving habit that the driver habitually makes and the driving skill of the driver; such as the level of a drive operation skill. Moreover; the message is provided for the driver only at a predetermined position corresponding to the accident information. Thus, it is difficult to appropriately warn and alert the driver.

Moreover, if, instead of the message for alerting the driver, the driver's driver operation and the travel status of the movable body are monitored to thereby automatically control the travel of the movable body actively, then it is technical difficult to realize easy and low-cost automatic control based on various types of input information

In contrast, according to the present invention, if it is recognized that it is close to the position at which the accident has occurred on the basis of the accident information under the control of the controlling device, for example, the predetermined message for alerting the driver is provided for the driver by the providing device in accordance with the added or subtracted score while the content is changed and it is controlled to be outputted or not to be outputted. Therefore, it is possible to quantify the driving habit that the driver habitually makes and the driving skill of the driver, such as the level of the drive operation skill, on the basis of the score.

As a result, it is possible to make the driver perceive a warning and an alert appropriately corresponding to an external factor about the position at which the accident has occurred or the situation in which the accident has occurred, in addition to or instead of an internal factor of the driving skill of the driver quantified, more effectively and easily. As a result, it is possible to realize the proactive safe driving by the driver, effectively and easily.

In one aspect of the navigation apparatus for the movable body of the present invention, it is further provided with a first storing device for storing the accident information, the controlling device controlling the providing device to provide the predetermined message, on the basis of the stored accident information (if it is close to the position at which the accident has occurred).

According to this aspect, the first storing device stores the accident information, which is about the position at which the accident has occurred or the situation in which the accident has occurred. Then, under the control of the controlling device, the predetermined message is provided by the providing device, on the basis of the stored accident information, such as the position at which the accident has occurred.

As a result, it is possible to make the driver perceive a warning and an alert appropriately corresponding to an external factor about the position at which the accident has occurred or the situation in which the accident has occurred, in addition to or instead of an internal factor of the driving skill of the driver quantified, more effectively and easily.

In an aspect associated with the controlling device, as described above, it may be further provided with a route searching device for searching for a route until the movable body arrives at a destination, the controlling device further controlling the route searching device to search for the route, on the basis of the stored accident information.

By virtue of such construction, under the controlling device, the route appropriately corresponding to the external factor about the position at which the accident has occurred or the situation in which the accident has occurred can be searched for by the route searching device. As a result, it is possible to realize the proactive safe driving by the driver, effectively and easily.

In another aspect of the navigation apparatus for the movable body of the present invention, the controlling device controls the providing device not to provide the message.

According to this aspect, it is possible to make the driver perceive a warning and an alert appropriately corresponding to the driving skin of the driver quantified on the basis of not providing the message, more effectively and easily.

In another aspect of the navigation apparatus for the movable body of the present invention, it is further provided with a second storing device (accumulating device) for storing the added or subtracted score, the controlling device controlling the providing device to provide the predetermined message, on the basis of the stored score (total score).

According to this aspect, it is possible to quantify the driving skill of the driver, more highly accurately and appropriately, on the basis of the stored score, such as a large amount of stored score.

In another aspect of the navigation apparatus for the movable body of the present invention, it is further provided with a third storing device for storing map information about an area in which the movable body travels, the controlling device further controlling the providing device to provide the predetermined message, on the basis of the stored map information and a time length or a time point in which the movable body travels.

According to this aspect, under the control of the controlling device, the predetermined message is provided by the providing device on the basis of the map information stored by the third storing device and the time length or the time point in which the movable body travels.

As a result, it is possible to make the driver perceive a warning and an alert appropriately corresponding to an external factor about the stored map information and the time length or the time point in which the movable body travels, in addition to or instead of an internal factor of the driving skill of the driver quantified, more effectively and easily. As a result, it is possible to realize the proactive safe driving by the driver, effectively and easily.

In another aspect of the navigation apparatus for the movable body of the present invention, it is further provided with a first receiving device for receiving traffic information as for a traffic state in an area in which the movable body travels, the controlling device further controlling the providing device to provide the predetermined message, on the basis of the received traffic information.

According to this aspect, under the control of the controlling device, the predetermined message is provided by the providing device, on the basis of the traffic information about the traffic state in the area in which the movable body travels, which is received by the first receiving device through e.g. a VICS (Vehicle Information Communication System) or the like.

As a result, it is possible to make the driver perceive a warning, and an alert appropriately corresponding to an external factor about the received traffic state in the area in which the movable body travels, in addition to or instead of an internal factor of the driving skill of the driver quantified, more effectively and easily. As a result, it is possible to realize the proactive safe driving by the driver, effectively and easily.

In another aspect of the navigation apparatus for the movable body of the present invention, the judging device judges the degree of risk, on the basis of items in which the drive is typified, the score processing device adds or subtracts the score in each of the items, and the controlling device controls the providing device to provide the predetermined message, on the basis of the score added or subtracted in each of the items (by a unit of item score).

According to this aspect, by virtue of the judging device, the degree of risk, which indicates the degree of dangerousness, in the driving of the diver is judged, more highly accurately on the basis of the items in which the drive is typified.

As a result, it is possible to make the driver perceive a warning and an alert appropriately corresponding to the driving skill of the driver which is quantified more accurately on the basis of the highly accurate judgment, more effectively and easily. As a result, it is possible to realize the proactive safe driving by the driver, effectively and easily.

In another aspect of the navigation apparatus for the movable body of the present invention, the judging device judges the degree of risk on the basis of a traffic rule (the limited speed, stop, no U-turn allowed), a road type (expressway), a travel status (speed), a travel position, and a travel time length or time point.

According to this aspect, by virtue of the judging device, it is possible to more highly accurately judge the degree of risk, which indicates the degree of dangerousness, in the driving of the driver, on the basis of the predetermined traffic rule, such as the set limited speed, the duty to stop, and no U-turn allowed, the road type (e.g. expressway), the travel status (e.g. speed), the travel position, and the travel time length or time point.

In another aspect of the navigation apparatus for the movable body of the present invention, it is further provided with a second receiving device for receiving the accident information about at least the position, from (iii) the position at which the accident has occurred and (iv) the situation in which the accident has occurred (a time, property damage, turning right without stopping at an intersection), the controlling device further controlling the providing device to provide the predetermined message on the basis of the received accident information (if it is close to the position at which the accident has occurred).

According to this aspect, by virtue of the second receiving device, the received accident information can be updated. In addition, since the accident information can be updated as needed during travelling, it is possible to inhibit the consumption of the capacity of the memory apparatus.

(Navigation Method for Movable Body)

Hereinafter, the navigation method for the movable body of the present invention will be explained.

The above object of the present invention can be also achieved by a navigation method for a movable body provided with: a measuring process of measuring travel information, which is information about (i) a travel position of the movable body, which is driven by a driver, and (ii) a travel status (acceleration, an angular velocity, and a speed); a judging process of judging a degree of risk which indicates a degree of dangerousness in driving of the driver, on the basis of the measured travel information (not stopping near a school); a score processing process of adding or subtracting a score corresponding to the judged degree of risk; a providing process of providing a message for the driver; an obtaining process of obtaining accident information about at least a position, from (iii) the position at which an accident has occurred and (iv) a situation in which the accident has occurred (a time, property damage, turning right without stopping at an intersection); and a controlling process of controlling the providing process to provide a predetermined message (without any change in the content and any output) corresponding to the added or subtracted score (if the total score is greater than or equal to a threshold value), on the basis of the obtained accident information (if it is close to the position at which the accident has occurred).

According to the navigation method for the movable body of the present inventions it is possible to receive the same various benefits as those of the navigation apparatus for the movable body of the present invention described above.

Incidentally, in response to the various aspects of the navigation apparatus for the movable body of the present invention described above, the navigation method for the movable body of the present invention can also adopt various aspects.

(Navigation Program)

Hereinafter, the navigation program of the present invention will be explained.

The above object of the present invention can be also achieved by a computer program for controlling a computer provided in the navigation apparatus for the movable body of the present invention described above (including its various aspects), the computer program making the computer function as at least one portion of the measuring device, the judging device, the score processing device, the providing device, and the controlling device.

According to the navigation program of the present invention, the aforementioned navigation apparatus for the movable body of the present invention can be embodied relatively readily, by loading the computer program from a recording medium for storing the computer program, such as a ROM, a CD-ROM, a DVD-ROM, a hard disk or the like, into the computer, or by downloading the computer program, which may be a carrier wave, into the computer via a communication device.

Incidentally, in response to the various aspects of the navigation apparatus for the movable body of the present invention described above, the navigation program of the present invention can also adopt various aspects.

The above object of the present invention can be also achieved by a computer program product in a computer-readable medium for tangibly embodying a program of instructions executable by a computer provided for the navigation apparatus for the movable body of the present invention described above (including its various aspects), the computer program product making the computer function as at least one portion of the measuring device, the judging device, the score processing device, the providing device, and the controlling device.

According to the computer program product of the present invention, the aforementioned navigation apparatus for the movable body of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the lie, into the computer, or by downloading the computer program product, which may be a carrier wave, into the computer via a communication device. More specifically, the computer program product may include computer readable codes to cause the computer (or may comprise computer readable instructions for causing the computer) to function as the aforementioned navigation apparatus for the movable body of the present invention.

(Memory Medium)

Hereinafter the memory medium of the present invention will be explained.

The above object of the present invention can be also achieved by a memory medium storing the aforementioned computer program for controlling (including its various aspects).

According to the memory medium of the present invention, it is possible to make the computer appropriately function as the navigation apparatus for the movable body of the present invention described above, by making the computer read the computer program for controlling, described above.

These effects and other advantages of the present invention will become more apparent from an embodiment explained below.

As explained above, according to the navigation apparatus and method for the movable body of the present invention, it is provided with the measuring device and process, the judging device and process, the score processing device and process) the providing device and process, and the controlling device and process, respectively. As a result, it is possible to make the driver perceive a warning and an alert appropriately corresponding to the quantified driving skill of the driver, more effectively and easily. As a result, it is possible to realize the proactive safe driving by the driver, effectively and easily.

Moreover, according to the navigation program of the present invention, it makes the computer function as the navigation apparatus for the movable body of the present invention described above, which enables the computer to make the driver perceive a warning and an alert appropriately corresponding to the quantified driving skill of the driver, more effectively and easily. As a result, it is possible to realize the proactive safe driving by the driver, effectively and easily.

Furthermore, according to the memory medium of the present invention, it is possible to make the computer appropriately function as the navigation apparatus for the movable body of the present invention described above, by making the computer read the navigation program described above.

### BRIEF DESCRIPTION OF DRAWINGS

FIG. 1 is a block diagram conceptually showing the basic structure of a navigation apparatus, which performs a route search and a route guidance while providing a predetermined message on the basis of a score to be added or subtracted in accordance with the degree of risk, in an embodiment.

FIG. 2 is a flowchart showing an entire flow of the operations of the navigation apparatus, including a process of controlling the provision of the predetermined message and a process of adding or subtracting the score, in the embodiment.

FIG. 3 is a flowchart showing a flow of the process of controlling the provision of the predetermined message, in the embodiment.

FIG. 4 is a tale showing the content of an accident history database, which is one specific example of the accident information, in the embodiment.

FIG. 5 is a table showing the content of the predetermined message corresponding to the degree of risk and the score, and timing in which the message is provided, in the embodiment.

FIG. 6 is a flowchart showing a flow of the process of adding or subtracting the score, in the embodiment.

FIG. 7 is a table showing the values of a weighting score and the score to be added or subtracted in accordance with a drive operation with a relatively high degree of risk, in the embodiment.

FIG. 8 are a view showing a display screen which displays one example of a route on which a driver “Mr. Kou” drives the movable body (FIG. 8(a)) and a graph showing the transition of the score changed along the route (FIG. 8(b)).

### DESCRIPTION OF REFERENCE CODES

10 navigation apparatus
11 GPS receiver
12 positioning device for vehicle information
13 communication apparatus
14 memory apparatus
15 map database (map DB)
16 accident history database
17 route search device
18 route guidance device
19 screen display device
20 audio output device
21 input device
22 CPU

### BEST MODE FOR CARRYING OUT THE INVENTION

Hereinafter, the best mode for carrying out the present invention will be explained in each embodiment in order with reference to the drawings. Incidentally the following explains an example in which the present invention is applied to an on-vehicle navigation apparatus.

(1) Basic Structure

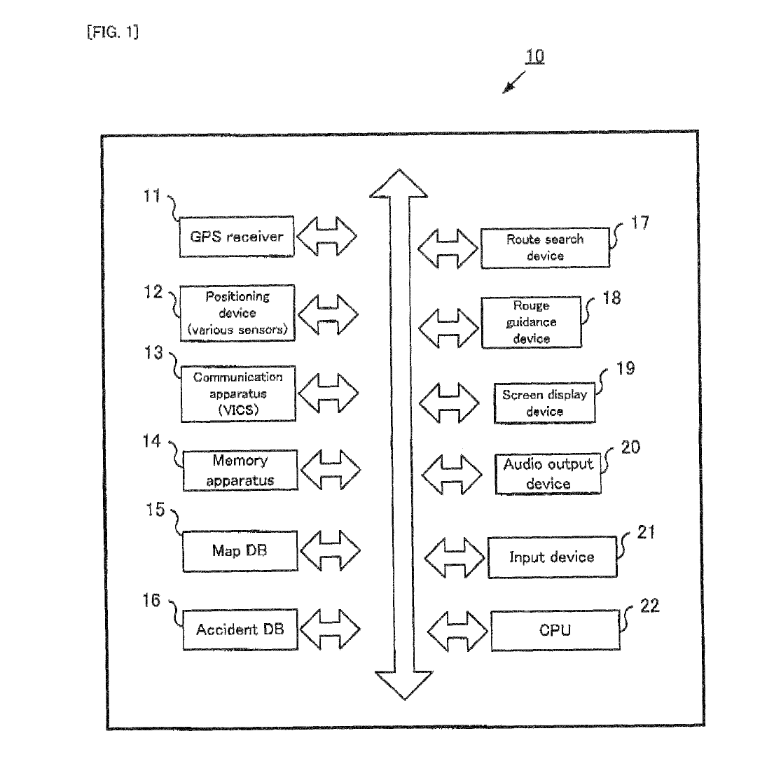

Firstly, with reference to FIG. 1, an explanation will be given on the basic structure of a navigation apparatus in an embodiment. FIG. 1 is a block diagram conceptually showing the basic structure of the navigation apparatus, which performs a route search and a route guidance while providing a predetermined message on the basis of a score to be added or subtracted in accordance with the degree of risk, in the embodiment.

As shown in FIG. 1, a navigation apparatus 10 is provided with: a GPS receiver 11; a positioning device 12 for vehicle information; a communication apparatus 13; a memory apparatus 14; a map database (map DB) 15; an accident history database 16; a route search device 17; a route guidance device 18; a screen display device 19; an audio output device 20; an input device 21; and a CPU 22.

The GPS receiver 11 receives a radio wave 19 which carries downlink data including positioning data, from a plurality of GPS satellites. The positioning data is used to detect an absolute position of a vehicle from latitude and longitude information or the like.

The positioning device 12 for vehicle information is provided with: an acceleration sensor; an angular velocity sensor; and a distance sensor, and measures a current position of the vehicle, on the basis of the vehicle information, such as a vehicle acceleration, a vehicle speed, and a vehicle angular velocity, and the map database. Specifically, the acceleration sensor is formed of e.g. a piezo element, detects the vehicle acceleration, and outputs acceleration data. The angular velocity sensor is formed of e.g. a vibratory gyroscope, detects the vehicle angular velocity when the vehicle changes its direction, and outputs angular velocity data and relative orientation data. The distance sensor measures a vehicle-speed pulse, which is formed of a pulse signal generated with the rotation of the wheels of the vehicle. Incidentally, one example of the communicating device is constructed of the positioning device 12 for vehicle information and the GPS receiver 11.

The communication apparatus 13 has a function of communicating a judgment result of the degree of learning of a driver with an information distributing apparatus, such as a server. Moreover, the communication apparatus 13 can designate a route to preferentially be stored, for the driver. The communication apparatus 13 is provided with a FM tuner, a beacon receiver, a mobile phone, an exclusive communication card, or the like. The communication apparatus 13 receives road traffic information, such as traffic jam and traffic information, and other information, which are distributed from a VCS (Vehicle Information Communication System) center through a communication interface. In particular, the communication apparatus 13 may receive the accident history database (accident DB) 16 described later through a predetermined network. As a result, the accident history database can be updated. In addition, the accident history database can updated as needed during travelling, so that it is possible to inhibit the consumption of the capacity of the memory apparatus.

The memory apparatus 14 is provided with a HDD (Hard Disc Drive) or the like. The memory apparatus 14 is a unit for storing various data used for a navigation process, such as map data and facility data.

The map database (map DB) 15 stores a map database for the route search and the route guidance.

The accident history database (accident DB) 16 is a database including at least position information about an accident occurrence point. Incidentally, the details of the accident history database 16 will be described later.

The route search device 17 searches for a route to the set destination, under the control of the CPU 22 described later. The route search device 17 performs route setting if the destination is set by a user, such as the driver. A specific method of performing the route setting will be briefly described. If the route setting is performed, the user, such as the driver, operates an input apparatus, to thereby set the destination and instruct the navigation apparatus 10 to search for a route. The route search device 17 retrieves a necessary link and node information from a data memory unit and calculates the route. Then, the route search device 17 stores route information with necessary map information into a buffer memory; and displays a map and the route to the destination on the display screen of a display. Incidentally, one example of the route searching device of the present invention is constructed of the route search device 17.

In particular, the route search device 17 can judge whether or not there is a point at which an accident has occurred, on the basis of the accident history database described later, on the searched route. Therefore, if it is judged that there is a point at which an accident has occurred on the route, the total of the accumulated score corresponding to the degree of risk in the drive operation may be calculated, and if the total is greater than or equal to a predetermined threshold value, the route search may be performed while avoiding the point at which the accident has occurred.

The route guidance device 19 displays the route and guidance information (guiding information) on the display screen, and performs the route guidance to the destination using audio.

The screen display device 19 displays various display data on a display apparatus, such as a display, under the control of the CPU 22 described later. Specifically, the map data is read from the data memory unit, under the control of the CPU 22. The screen display device 19 displays the map data read from the map database, on the display screen, such as a display. The screen display device 19 is provided with: a graphic controller for controlling the entire screen display device 19 on the basis of control data transmitted from the CPU 22 through a bus line; a buffer memory, which is provided with a memory such as a VRAM (Video RAM) and which temporarily stores image information that can be immediately displayed; a display control device for display-controlling a display, on the basis of image data outputted from the graphic controller; and the display. The display is provided with a liquid crystal display apparatus or the like with a diagonal length of 5 to 10 inches, and it is attached near a front panel in a vehicle.

The audio output unit 20 is provided with: a D/A (Digital to Analog) converter for performing a D/A conversion on audio digital data, which is transmitted through the bus line from a CD-ROM drive, a DVD-ROM, or a RAM or the like, under the control of the system controller 20; an amplifier (AMP) for amplifying an audio analog signal outputted from the D/A converter; and a speaker for converting the amplified audio analog signal to audio and outputting it into a vehicle. The audio output unit 20 performs audio guidance such as “After 300 m, turn right and After 100 m, turn right at a convenience store”, in predetermined timing, with regard to a guidance intersection to turn right or turn left at on the route, for the user. Therefore, the audio output unit 20 functions as the guiding device.

The input device 21 is provided with a key, a switch, a button, a remote controller, an audio input apparatus, or the like, for inputting various commands and data. The input device 21 is disposed in the surroundings of the display and the front panel of the main body of the on-vehicle electronic system equipped in the vehicle. Moreover, if the display is of a touch panel type, a touch panel provided on the display screen of the display also functions as the input device 21. The touch panel functions as the inputting device of the present invention.

The CPU (Central Processing Unit) 22 integrally controls the navigation apparatus 10 in the embodiment. Incidentally, one example of the controlling device and the judging device of the present invention is constructed of the CPU 22.

Incidentally; in the embodiment, the intersection merely indicates one example of the guidance point, and the present invention can be similarly applied to another guidance point, such as an entrance and an exit of an express way and a toll road, and an interchange, and other points at which the travel direction of the vehicle needs to be changed, instead of the intersection.

(2) Operation Principle

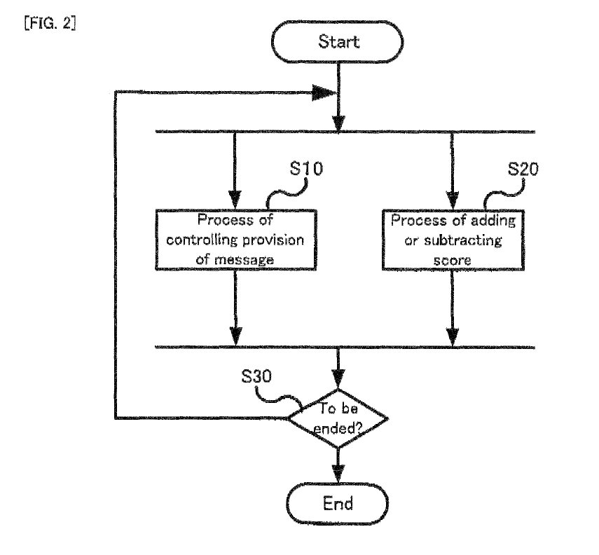

Next, with reference to FIG. 2 to FIG. 7, an explanation will be given on an operation principle of the navigation apparatus, including a process of controlling the provision of the predetermined message and a process of adding or subtracting the score, in the embodiment.

(2-1) Entire Operation

Firstly, with reference to FIG. 2, an explanation will be given on an entire flow of the operations of the navigation apparatus 10 in the embodiment. FIG. 2 is a flowchart showing the entire flow of the operations of the navigation apparatus 10, including the process of controlling the provision of the predetermined message and the process of adding or subtracting the score, in the embodiment. Incidentally, the process of controlling the provision of the predetermined message and the process of adding or subtracting the score, in the embodiment, may be performed in the general route search and guidance until reaching the destination. Alternatively, the processes may be performed during normal traveling, in which the route search and guidance are not performed.

As shown in FIG. 2, in the navigation apparatus 10 in the embodiment, the process of controlling the provision of the predetermined message is performed, under the control of the CPU 22, after the movable body is started by the driver, for example (step S10). Simultaneously with and in tandem with this, the process of adding or subtracting the score is performed under the control of the CPU 22 (step S20). Incidentally, the details of the processes will be described later.

Next, under the control of the CPU 22, it is judged whether or not a series of operations is to be ended. If it is to be ended (step S30: Yes), the series of operations is ended. On the other hand, if it is not to be ended (the step S30: No), the process of controlling the provision of the predetermined message and the process of adding or subtracting the score described above are continued.

(2-2) Process of Controlling Provision of Message

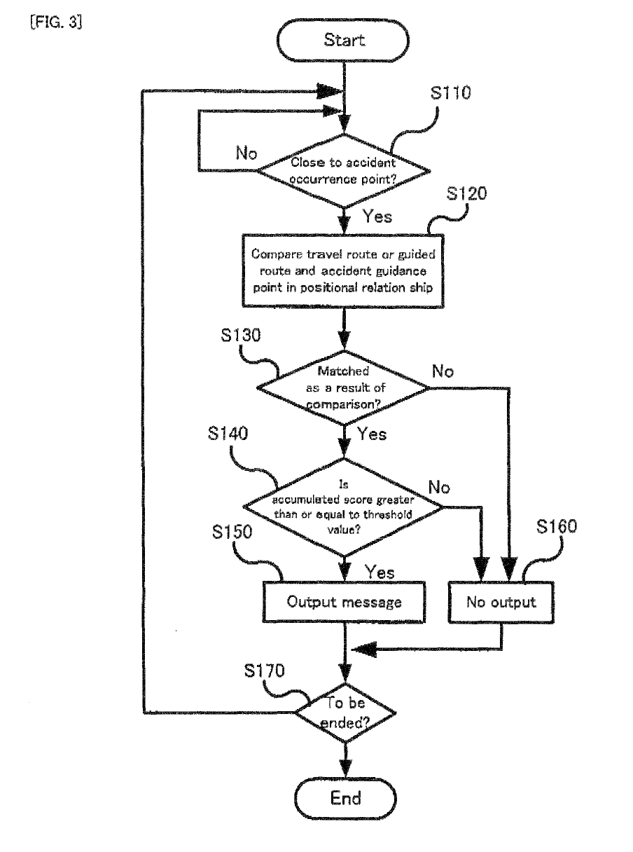

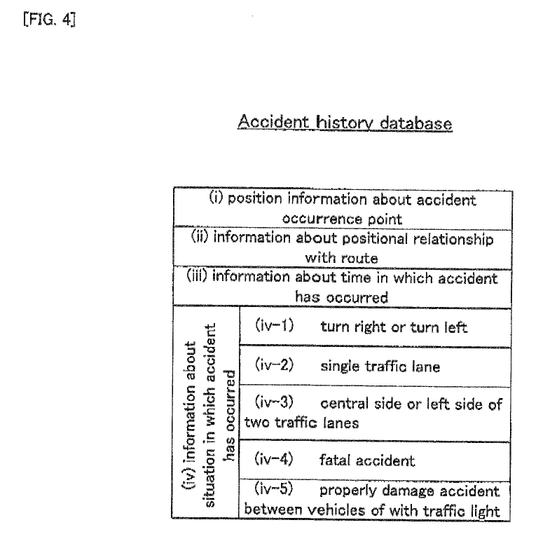

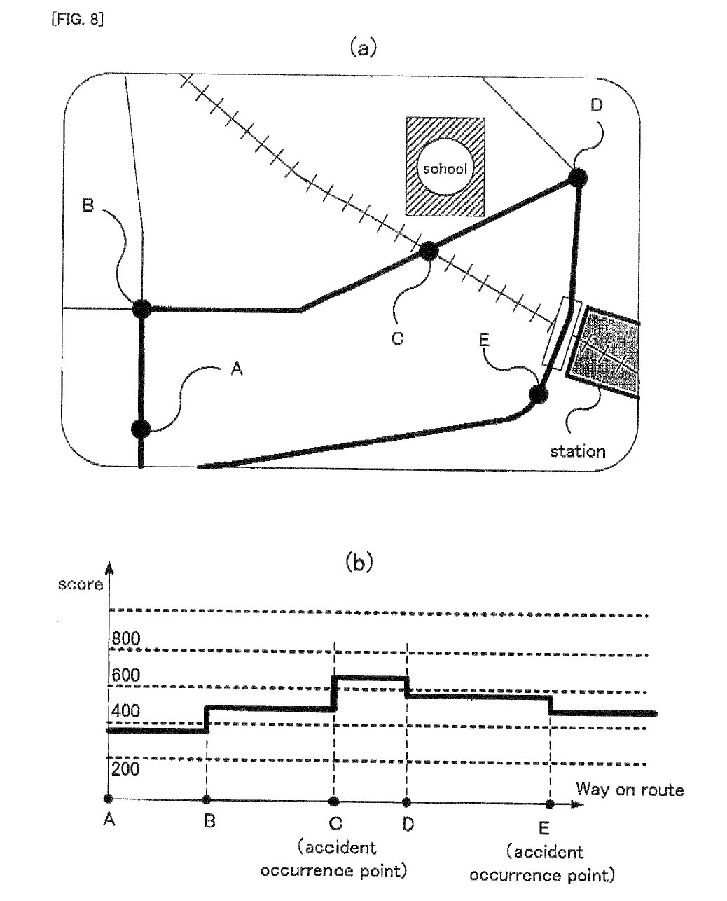

Next, with reference to FIG. 3 to FIG. 5, an explanation will be given on a flow of the process of controlling the provision of the predetermined message, in the embodiment. FIG. 8 is a flowchart showing the flow of the process of controlling the provision of the predetermined message, in the embodiment. FIG. 4 is a tale showing the content of an accident history database, which is one specific example of the accident information, in the embodiment.

As shown in FIG. 3, in the navigation apparatus for the movable body in the embodiment, it is judged whether or not the movable body is close to the accident occurrence point, on the basis of the accident history database, under the control of the CPU 22 (step S110). Here, the “accident history database” in the embodiment means the database including at least the position information about the accident occurrence point. Specifically, as shown in FIG. 4, the accident history database may include (i) the aforementioned position information about the accident occurrence point, and (ii) information about a positional relationship between the route that the movable body travels and the accident occurrence point, in other words, information which indicates on which route there is the accident occurrence point. Moreover, the accident history database may include (iii) information about a time in which the accident has occurred, such as a time zone, or (iv) information about the situation that the accident has occurred. More specifically, this (iv) information about the situation in which the accident has occurred, may include information based on the following five viewpoints. That is, it may include: (iv-1) information about in which case the accident has occurred, in the case that the movable body turned right or in the case that the movable body turned left; (iv-2) information about in which case the accident has occurred, in a single traffic lane or not; (iv-3) information about in which case the accident has occurred, in a central-side traffic lane of two traffic lanes or in a left-side traffic lane of the two traffic lanes; (iv-4) information about whether or not the occurred accident is a fatal accident; and (iv-5) information about whether the occurred accident, which is a properly damage accident, is between the vehicles or between the vehicle and a traffic light.

As a result of the judgment in the step S110 described above, if it is judged that the movable body is close to the accident occurrence point (the step S110: Yes), (i) the travel route on which the movable body is now travelling or (ii) the guided route to the destination and (ii) the accident occurrence point are compared in their positional relationship, under the control of the CPU 22 (step S120). Then, under the control of the CPU 22, as a result of the comparison, it is judged whether or not the position of the traveling route or the guided route matches the position of the accident occurrence point, i.e. it is judged whether or not the accident occurrence point is positioned on the travel route or the guided route (step S130). As a result of the comparison in the step S130, if the position of the traveling route or the guided route matches the position of the accident occurrence point, i.e. if the accident occurrence point is positioned on the travel route or the guided route (the step S130: Yes), moreover, it is judged whether or not the score added or subtracted and accumulated on the memory apparatus, is greater than or equal to the predetermined threshold value, under the control of the CPU 22 (step S140). If the score added or subtracted and accumulated is greater than or equal to the predetermined threshold value (the step S140: Yes), the predetermined message is provided for the driver; namely, the predetermined message is outputted to the driver, under the control of the CPU 22 (step S150).

(2-2-1) Relationship Among Score, Content of Message, and Provision Timing

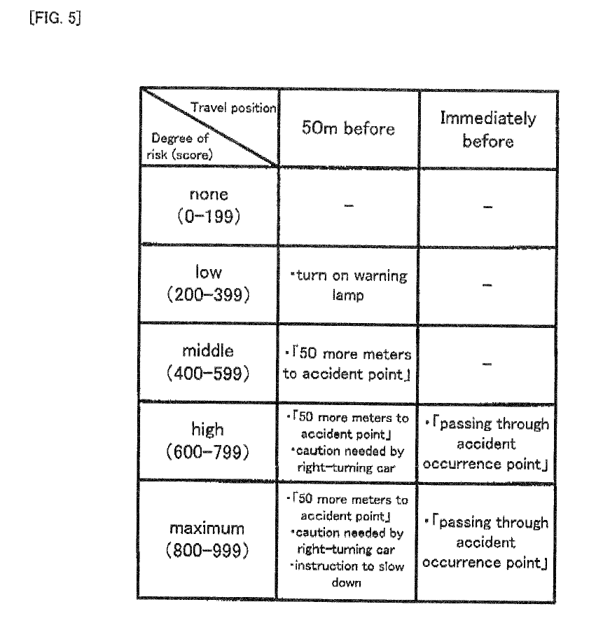

Now, with reference to FIG. 5, an explanation will be given on (i) the content of the predetermined message corresponding to the degree of risk and the score, and (ii) timing in which the message is provided, in the embodiment. FIG. 5 is a table showing one example of (i) the content of the predetermined message corresponding to the degree of risk and the score, and (ii) timing in which the message is provided, in the embodiment.

As shown in FIG. 5, under the control of the CPU 22, (i) the content of the predetermined message, which is provided for the driver, and (ii) the provision timing may be changed on the basis of a threshold value or range of the score corresponding to the degree of risk which indicates the degree of dangerousness in the driver's driving. Incidentally, the score shown in FIG. 5 is “0 points” to “999 points”. Even if the overflow or underflow of the score occurs, a special process does not have to be performed. Alternatively, if the overflow of the score occurs, the message may be always provided.

Specifically, if the degree of risk which indicates the degree of dangerousness in the driver's driving, is low, i.e. if the accumulated score is eater than or equal to a predetermined threshold value “200 points” and less than “400 points”, an index, such as a warning lamp, which indicates that the movable body is close to the accident occurrence point, is provided for the driver, 50 meters before the movable body passes through the accident occurrence point. Incidentally, the message may not be provided immediately before the movable body passes through the accident occurrence point.

Moreover, if the degree of risk which indicates the degree of dangerousness in the driver's driving, is middle, i.e. if the accumulated score is greater than or equal to the predetermined threshold value “400 points” and less than “600 points”, a message or index which indicates “50 more meters to the accident point” is provided for the driver, 50 meters before the movable body passes through the accident occurrence point. Incidentally the message may not be provided immediately before the movable body passes through the accident occurrence point.

Moreover, if the degree of risk which indicates the degree of dangerousness in the driver's driving, is high, i.e. if the accumulated score is greater than or equal to the predetermined threshold value “600 points” and less than “800 points”, the message or index which indicates “50 more meters to the accident point” and a message which indicates “caution needed by a right-turning car” as the information about the situation that the accident has occurred, are provided for the driver, 50 m before the movable body passes through the accident occurrence point. Moreover, a message which indicates “passing through the accident occurrence point” is provided for the driver immediately before the movable body passes through the accident occurrence point.

Moreover, if the degree of risk which indicates the degree of dangerousness in the driver's driving is maximum, i.e. if the accumulated score is greater than or equal to the predetermined threshold value “800 points” and less than “1000 points”, the message or index which indicates “50 more meters to the accident point”, the message which indicates “caution needed by a right-turning car” as the information about the situation that the accident has occurred, and a message which gives an instruction of “immediate slowdown” are provided for the driver, 50 m before the movable body passes through the accident occurrence point. Moreover, the message which indicates “passing through the accident occurrence point” is provided for the driver immediately before the movable body passes through the accident occurrence point.

Incidentally, in addition to the change in the content of the provided message, a provision method and a provision feature for the driver, such as display frequency to be displayed and a volume level of the outputted audio, may be changed. Moreover, in addition to or instead of changing the content of the provided message on the basis of whether or not the total of the accumulated score is greater than or equal to the predetermined threshold value, as described above, the content of the provided message may be changed on the basis of whether or not the subtotal of the score accumulated or tallied with the item of the drive operation as a unit, is greater than or equal to a predetermined threshold, as described later.

(2-2) Process of Controlling Provision of Message (Continued)

Again, back in FIG. 3, as a result of the comparison in the step S130 described above, if the position of the traveling route or the guided route does not match the position of the accident occurrence point, i.e. if the accident occurrence point is not positioned on the travel route or the guided route (the step S130: No), the message is not provided; namely, the message is not outputted, under the control of the CPU 22 (step S10). Moreover, as a result of the judgment in the step S140 described above, if the score added or subtracted and accumulated is less than the predetermined threshold value (the step S140: No), the message is not provided; namely, the message is not outputted, under the control of the CPU 22 (the step S160). Specifically, as shown in FIG. 5, if the degree of risk which indicates the degree of dangerousness in the driver's driving, is almost or completely none, i.e. if the accumulated score is “0 point” to “199 points”, the message is not provided, either 50 meters before the movable body passes through the accident occurrence point or immediately before passing through the accident occurrence point.

Then, under the control of the CPU 22, it is judged whether or not the process of controlling the provision of the message is to be ended (step S170). Here, if it is judged that the process of controlling the provision of the message is to be ended (the step S170: Yes), the series of process of controlling the provision of the message, is ended. On the other hand, if it is judged that the process of controlling the provision of the message is not to be ended (the step S170: No), as described above, it is judged whether or not the movable body is close to the accident occurrence point on the basis of the accident history database, under the control of the CPU 22 (the step Silo).

(2-3) Process of Adding or Subtracting Score

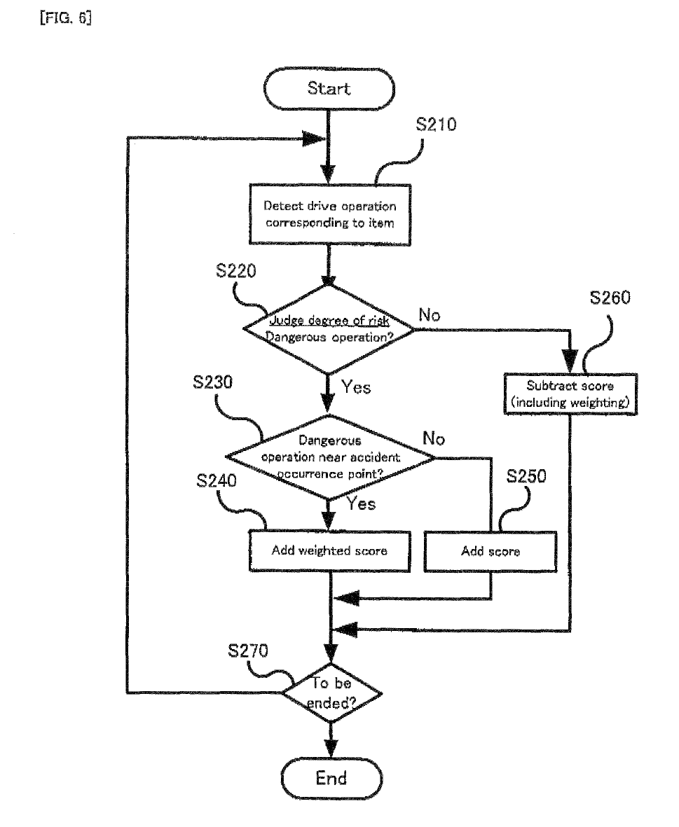

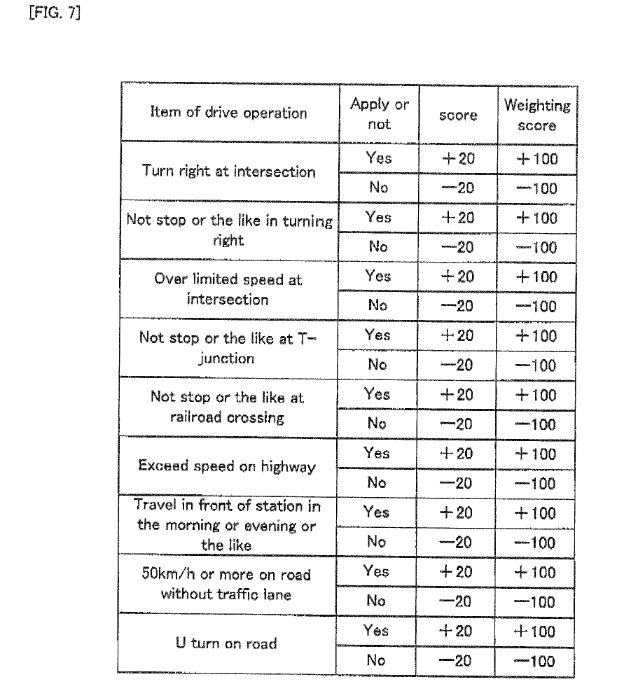

Next, with reference to FIG. 6 and FIG. 7, an explanation will be given on a flow of the process of adding or subtracting the score, in the embodiment. FIG. 6 is a flowchart showing the flow of the process of adding or subtracting the score, in the embodiment.

As shown in FIG. 6, firstly, under the control of the CPU 22, the drive operation is detected, on the basis of items in which the drive operation with a relatively high degree of risk, is typified (step S210).

Then, under the control of the CPU 22, the degree of risk in the detected drive operation, is judged, and it is judged whether or not to be the drive operation with the relatively high degree of risk (step S20). Here, if it is judged to be the drive operation with the relatively high degree of risk (the step S220: Yes), moreover, it is judged whether or not a travel position or a traveling position at which the drive operation with the relatively high degree of risk is detected, is near the aforementioned accident occurrence point, under the control of the CPU 22 (step S230). Here, if it is judged that the travel position at which the drive operation with the relatively high degree of risk is detected, is near the aforementioned accident occurrence point (the step S230: Yes), a weighted score is added to the score accumulated on the memory apparatus, under the control of the CPU 22 (step S240).

(2-3-1) Value of Score to be Added or Subtracted

Now, with reference to FIG. 7, an explanation will be given on a weighting score and the score to be added or subtracted in accordance with the drive operation with the relatively high degree of risk, in the embodiment. FIG. 7 is a table showing the values of the weighting score and the score to be added or subtracted, in accordance with the drive operation with the relatively high degree of risk, in the embodiment.

As shown in FIG. 7, if the movable body turns right at the intersection on two track lanes or a right-turn-only track lane, which is one example of the drive operation with the relatively high degree of risk, in the embodiment, “20 points” is added as the score. On the other hand, if the movable body does not turn right at the intersection on the two track lanes or the right-turn-only track lane, “20 points” is subtracted as the score. In particular, if this one example of the drive operation with the relatively high degree of risk, is performed near the aforementioned accident occurrence point, “100 points” is added as the weighted score. On the other hand, (i) if this one example of the drive operation with the relatively high degree of risk, is not performed daring the travelling on the route with a predetermined distance and (ii) if the accumulated score is in a predetermined relatively low range, “100 points” is subtracted as the weighted score.

Moreover, if the movable body does not stop nor slow down when turning right at the intersection on a single track lane or the like, which is another example of the drive operation with the relatively high degree of risk, in the embodiment, “20 points” is added as the score. On the other hand, if the movable body stops or slows down when turning right at the intersection on a single track lane or the like, “20 points” is subtracted as the score. In particular, if this another example of the drive operation with the relatively high degree of risk, is performed near the aforementioned accident occurrence point, “100 points” is added as the weighted score. On the other hand, (i) if this another example of the drive operation with the relatively high degree of risk is not performed during the travelling on the route with the predetermined distance and (ii) if the accumulated score is in the predetermined relatively low range, “100 points” is subtracted as the weighted score.

As described above, even in this another example of the drive operation with the relatively high degree of risk in the embodiment, the score is added or subtracted substantially in the same manner. Hereinafter, other examples of the drive operation with the relatively high degree of risk in the embodiment, will be listed: (i) the case that the movable body passes through, turns right or left, or goes straight, over the speed limit, at the intersection on the two traffic lanes or right-turn-only lane; (ii) the case that the movable body does not stop or stops for a long time immediately before a T-junction; (ii) the case that the movable body does not stop once immediately before a railroad crossing; (iv) the case that the movable body exceeds the legal speed on an expressway; (v) the movable body travels in front of a station, in a residential neighborhood, near a school, and on a school road in the morning or the evening; (vi) the case that the movable body travels for example at a speed of 50 km per hour on a narrow road without a traffic lane at night or the like; and (vii) the case that the movable body makes a U-turn on a road.

(2-3) Process of Adding or Subtracting Score (Continued)

Back in FIG. 6 again, it is judged whether or not the process of adding or subtracting the score is to be ended, under the control of the CPU 22 (step S270). Here, if it is judged that the process of adding or subtracting the score is to be ended (the step S270: Yes), the series of process of adding or subtracting the score is ended. On the other hand, if it is judged that the process of adding or subtracting the score is not to be ended (the step S270: No), as described above, the drive operation is detected on the basis of the items in which the drive operation with the relatively high degree of risk, is typified, under the control of the CPU 22 (the step S210).

(3) Study of Operation and Effect in Embodiment

Next, with reference to FIG. 8, the operation and effect in the embodiment will be studied FIG. 8 are a view showing the display screen (FIG. 8(a)) which displays one example of the route on which a driver “Mr. Kou” drives the movable body, and a graph (FIG. 8(b)) showing the transition of the score changed along the route. Incidentally, a “point A” to a “point E” indicate points, such as the intersection, on the route on which the movable body travels.

According to the embodiment, under the control of the CPU 22, the predetermined message is provided for the driver while a) the content is changed and (ii) it is controlled that the output is performed or not, on the basis of the total of the added or subtracted score. Therefore, it is possible to quantify (i) the driving habit that the driver habitually makes and (ii) the driving skill of the driver, such as the level of a drive operation skill, on the basis of the score.

Specifically, as shown in FIG. 8(a), by the driver “Mr. Kou”, the traveling movable body passes through the “point A”, to the “point E” on the route. The total of the accumulated score at the “point A”, is “380 points”. Therefore, as described above, the total of the accumulated score is greater than or equal to the predetermined threshold value “200 points”, so that the index, such as a warning lamp, which indicates that the movable body is close to the accident occurrence point, is provided for the driver, 50 meters before the movable body passes through the accident occurrence point.

Then, since the driver “Mr. Kou” made the movable body turn right at the “point B”, i.e. at an intersection on two traffic lanes or a right-turn-only traffic lane, “20 points” is added in the score. In addition, since the driver “Mr. Kou” made the movable body turn right over the limited speed at the same “point B”, another “20 points” is added in the score. Therefore, the total of the accumulated score at “the point B” is “420 points”. That is, the total of the accumulated score is greater than or equal to the predetermined threshold value “400 points”, so that the message or index which indicates “50 more meters to the accident point” is provided for the driver, 50 meters before the movable body passes through the accident occurrence point.

Then, since the driver “Mr. Kou” did not make the movable body stop at the “point C” at which the accident occurred in the past, i.e. immediately before a railroad crossing, “100 points” is weight-added in the score. In addition, since the driver “Mr. Kou” made the movable body travel near a school in the morning at the “point C” at which the accident occurred in the past, another “100 points” is weight-added in the score. Therefore, the total of the accumulated score at “the point C” is “620 points”. That is, the total of the accumulated score is greater than or equal to the predetermined threshold value “600 points”, so that the message or index which indicates “50 more meters to the accident point” and the message which indicates “caution needed by a right-turning car” as the information about the situation that the accident has occurred, are provided for the driver, 50 meters before the movable body passes through the accident occurrence point. Moreover, the message which indicates “passing through the accident occurrence point” is provided for the driver immediately before the movable body passes through the “point C”, which is the accident occurrence point.

Then, since the driver “Mr. Kou” made the movable body stop at the “point D”, i.e. immediately before a T-junction, “20 points” is subtracted in the score. In addition, since the drier “Mr. Kou” appropriately turned on a direction indicator, another “20 points” is subtracted in the score. Therefore, the total of the accumulated score at “the point D is “580 points”. That is, the total of the accumulated score is greater than or equal to the predetermined threshold value “400 points”, so that the message or index which indicates “50 more meters to the accident point” is provided for the driver, 50 meters before the movable body passes through the accident occurrence point.

Then, since (i) the driver “Mr. Kou” did not make the movable body travel at the “point E”, i.e. in front of a station, in the morning and (ii) the driver “Mr. Kou” did not perform a dangerous operation during the travelling on the route with a predetermined distance and (ii) the accumulated score is in a predetermined relatively low range (e.g. m a range lower than “600 points”), “100 points” is weight-subtracted in the score. Therefore, the total of the accumulated score at the “point E” is “480 points”. That is, the total of the accumulated score is greater than or equal to the predetermined threshold value “400 points”, so that the message or index which indicates “50 more meters to the accident point” is provided for the driver, 50 meters before the movable body passes through the accident occurrence point. If a movable body driven by a driver “Mr. Otsu” who is different from the driver “Mr. Kou” also passes through the “point A” to the “point E” on the route, the total of the accumulated score is changed appropriately in accordance with the driving skill and the driving habit of the driver “Mr. Otsu”. Then the predetermined message is provided, depending on whether or not the total of the accumulated score is greater than or equal to the predetermined threshold value.

As a result, it is possible to make the driver perceive a warning and an alert appropriately corresponding to the quantified driving skill of the driver, such as the driving skill of “Mr. Kou” or the driving skill of “Mr. Otsu”, more effectively and easily. As a result, it is possible to realize the proactive safe driving by the driver, effectively and easily.

In the aforementioned embodiment, the on-vehicle car navigation apparatus is explained as one example of the navigation apparatus for the movable body. The present invention, however, may be applied to a mobile navigation apparatus mounted on information equipment, such as a mobile phone and a PDA (Personal Digital Assistant).

The present invention is not limited to the aforementioned embodiment, but various changes may be made, if desired, without departing from the essence or spirit of the invention which can be read from the claims and the entire specification. A navigation apparatus and method, a computer program and a memory media, all of which involve such changes, are also intended to be within the technical scope of the present invention.

### INDUSTRIAL APPLICABILITY

The navigation apparatus and method, the navigation program, and the memory medium according to the present invention can be applied to a navigation apparatus which enable the driver to perceive a warning and an alert appropriately corresponding to the driving skill of the driver of the movable body and which can effectively realize the proactive safe driving by the driven. Moreover, they can be applied to a navigation apparatus or the like which is mounted on various computer equipment for consumer use or for commercial use, or which can be connected to various computer equipment.

1-13. (canceled)

14. A navigation apparatus for a movable body comprising:
an obtaining device for obtaining accident information including at least position information which indicates an occurrence position at which an accident has occurred, from an accident history database in which information about accidents in the past are accumulated;
a detecting device for detecting a drive operation of the movable body at a travel position of the movable body driven by a driver;
a holding device for connecting and holding a plurality of types of items about the drive operation of the movable body and a score;
a judging device for judging whether or not the detected drive operation is the same as any one drive operation included in the plurality of types of items;
a score processing device for (i) adding the score corresponding to the one drive operation if the detected drive operation is the same as the one drive operation and (ii) or subtracting the score corresponding to the one drive operation if the detected drive operation is not the same as the one drive operation;
a score totalizing device for calculating a total value of the added or subtracted score;
a providing device for providing a message according to the total value for the driver; and
a controlling device for controlling said providing device to provide the message corresponding to the total value, if a distance between (i) the occurrence position indicated by the position information included in the obtained accident information and (ii) the travel position, is less than a predetermined value.

15. The navigation apparatus for the movable body according to claim 14, wherein
said judging device judges whether or not to be any one drive operation included in the items in which the drive operation is typified, as the plurality of types of items,
said score processing device adds or subtracts the score corresponding to each of the typified items, and
said controlling device controls said providing device to provide a predetermined message, in accordance with magnitude of the total value of both the score added in each of the items and the score subtracted in each of the items.

16. A navigation method for a movable body comprising:
an obtaining process of obtaining accident information including at least position information which indicates an occurrence position at which an accident has occurred, from an accident history database in which information about accidents in the past are accumulated;
a detecting process of detecting a drive operation of the movable body at a travel position of the movable body driven by a driver;
a holding process of connecting and holding a plurality of types of items about the drive operation of the movable body and a score;
a judging process of judging whether or not the detected drive operation is the same as any one drive operation included in the plurality of types of items;
a score processing process of (i) adding the score corresponding to the one drive operation if the detected drive operation is the same as the one drive operation and (ii) subtracting the score corresponding to the one drive operation if the detected drive operation is not the same as the one drive operation;
a score totalizing process of calculating a total value of the added or subtracted score;
a providing process of providing a message according to the total value for the driver; and
a controlling process of controlling said providing process to provide the message corresponding to the total value, if a distance between (i) the occurrence position indicated by the position information included in the obtained accident information and (ii) the travel position, is less than a predetermined value.

17. A computer program for controlling a computer provided in the navigation apparatus of the movable body according to claim 14, said computer program making the computer function as at least one portion of said obtaining device, said detecting device, said holding device, judging device, said score processing device, said score totalizing device, said providing device, and said controlling device.

18. A memory medium storing the computer program for controlling, according to claim 17.

19. The navigation apparatus for the movable body according to claim 14, wherein said score processing device weights the score to be added and the score to be subtracted, if the distance between (i) the occurrence position indicated by the position information included in the obtained accident information and (ii) the travel position, is less than the predetermined value.

20. The navigation apparatus for the movable body according to claim 14, wherein said providing device always provides a predetermined message, if the total value calculated by said score totalizing device exceeds a predetermined upper limit value.
